(19) United States
(12) Patent Application Publication
(10) Pub. No.: US 2018/0103795 A1
(43) Pub. Date: Apr. 19, 2018

(54) MICROWAVABLE FOOD PACKAGE APPARATUS AND METHOD

(71) Applicant: Callan Sinclair, Mandeville, LA (US)

(72) Inventor: Callan Sinclair, Mandeville, LA (US)

(21) Appl. No.: 15/792,929

(22) Filed: Oct. 25, 2017

Related U.S. Application Data
(63) Continuation of application No. PCT/US2016/033532, filed on May 20, 2016.
(60) Provisional application No. 62/164,269, filed on May 20, 2015.

(51) Int. Cl. A47J 36/02; B65D 5/54; B65D 77/04; B65D 81/36; B65D 81/38; A47J 36/04; B65D 81/34

(52) U.S. Cl. CPC A47J 36/027; B65D 5/542; B65D 77/0433; B65D 81/3453; B65D 81/3818; A47J 36/04; B65D 81/36

(57) ABSTRACT

A microwavable food and package apparatus includes an outer container having an upper panel providing an upper surface, a lower panel providing a lower surface, a plurality of side walls that each extend from the upper panel to the lower panel, and an interior. One of the side walls having a removable portion that enables access to said interior such as when removing the contents/bowl. An inner container of bowl provides a cavity that holds a food item. The outer container lower panel has a having a removable section that can be removed to provide an opening in the upper panel. An annular wall on the inner container is sized and shaped to fit the opening. The outer container or box thus functions as a trivet, wherein a portion of the outer container extends away from the inner container after the inner and outer containers have been subjected to microwave cooking so that said portion of said outer container (e.g. corner) provides a cooler surface that can be gripped by a user without fear of burns.

### CROSS-REFERENCE TO RELATED APPLICATIONS

This is a continuation of Patent Cooperation Treaty application international application number PCT/US2016/033532, international filing date May 20, 2016, which was a non-provisional of U.S. provisional patent application Ser. No. 62/164,269, filed May 20, 2015. Each of these applications are incorporated herein by reference, and priority of each is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to microwavable food products and packaging. More particularly the present invention relates to an improved food product and package wherein the food item to be consumed it contained in a bowl that fits inside an outer container of a microwavable material such as cardboard or plastic and wherein a removable section of the box or outer container can be removed to form an opening that cradles the bowl or inner container so that a user can remove the assembly from a microwave oven after cooking by grasping the outer container which acts as an insulator or trivet thus protecting the user from burns.

### 2. General Background of the Invention

The following table lists patents that related generally to microwavable containers each listed patent hereby incorporated herein by reference.

| Patent No. | Title | Issue Date |
|---|---|---|
| 4,478,349 | Insulated Dish and Lid for | Oct. 12, 1984 |
| | Microwave Cooking | |
| 8,746,487 | Food Container | Jun. 10, 2014 |
| 4,477,705 | Microwave Oven Popcorn Popper, | Oct. 16, 1984 |
| | Steamer and Roaster | |

### BRIEF SUMMARY OF THE INVENTION

The present invention provides an improved, microwavable food and package apparatus that includes an outer container having an upper panel providing an upper surface, a lower panel providing a lower surface, a plurality of side walls that each extend from the upper panel to the lower panel, and an outer container hollow interior.

One of the side walls has a removable portion that enables access to the interior. An inner container has a cavity or concave portion that holds a food item to be warmed or cooked in a microwave oven.

The container lower panel has a removable section that can be removed to provide an opening (e.g. circular, oval, square, octagonal or other shape) in the lower panel.

An annular wall on the inner container is sized and shaped to fit the opening.

A removable portion on the top panel of the outer container is removed to provide an opening that holds the inner container. During cooking or warming, the apparatus is placed inside a microwave oven. The oven then heats the apparatus (outer container, inner container and contained food item) for a selected time period. The user then grabs the outer container and removes it from the oven. A user can carry the food item without needing a pot holder or glove as the outer container is an insulator or trivet that transfers little or no heat to the user's hand. The outer container is preferably of a low head transfer index material such as cardboard or paper.

A portion of the outer container (e.g. box corner or side portion) extends away from the inner container after the inner and outer containers have been subjected to microwave cooking so that corner or edge portion of the outer container provides a cooled part for gripping by a user.

In one embodiment, the outer container is of a paper material.

In one embodiment, the outer container is of a cardboard material.

In one embodiment, the outer container is of a plastic material.

In one embodiment, the upper and lower panels are each rectangular.

In one embodiment, the inner container is of a plastic material.

In one embodiment, the inner container is a bowl.

In one embodiment, the inner container has a circular bottom.

In one embodiment, the inner container has an open top.

In one embodiment, the inner container includes a frusto-conical side wall.

In one embodiment, the inner container has one or more handles.

In one embodiment, the removable portion of the upper panel is surrounded by a serrated portion.

In one embodiment, the removable portion of the upper panel is surrounded by perforations.

In one embodiment, the removable portion of the upper panel is surrounded one or more scores.

In various embodiments the food container includes refrigerator and shelf stable foods as well as frozen because.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of the carton and food container combination showing the top of the carton.

FIG. 2 is a perspective view of the carton and food container combination flipped about the arrow shown in FIG. 1, and now showing the bottom of the carton with perforations facilitating the removal of removable portion.

FIG. 3 is a set of graphical instructions for a user on how to use the carton and food container combination when heating in a microwave.

FIGS. 4 through 6 are perspective views showing removal of a side wall or side panel of the carton being opened to provide access to the food container stored in the interior of the carton.

FIG. 7 is a top view of the carton and food container combination showing the food container being removed from a side of the carton.

FIG. 8 is a top view of the carton and food container combination showing the food container now removed from a side of the carton.

FIG. 9 is a bottom view of the carton showing the removable portion being partially removed from the carton by use of the perforations.

FIG. 10 is a bottom view of the carton showing the removable portion now completely removed from the carton by use of the perforations.

FIG. 11 is a perspective view of the removable cover of the microwave container being removed, and then schematically showing the food container being inserted into the interior of the carton through the access opening located on the bottom of the carton.

FIG. 12 is a side perspective view of the food container now positioned in the interior of the carton through the access opening located on the bottom of the carton.

### DETAILED DESCRIPTION OF THE PREFERRED EMBODIMENT

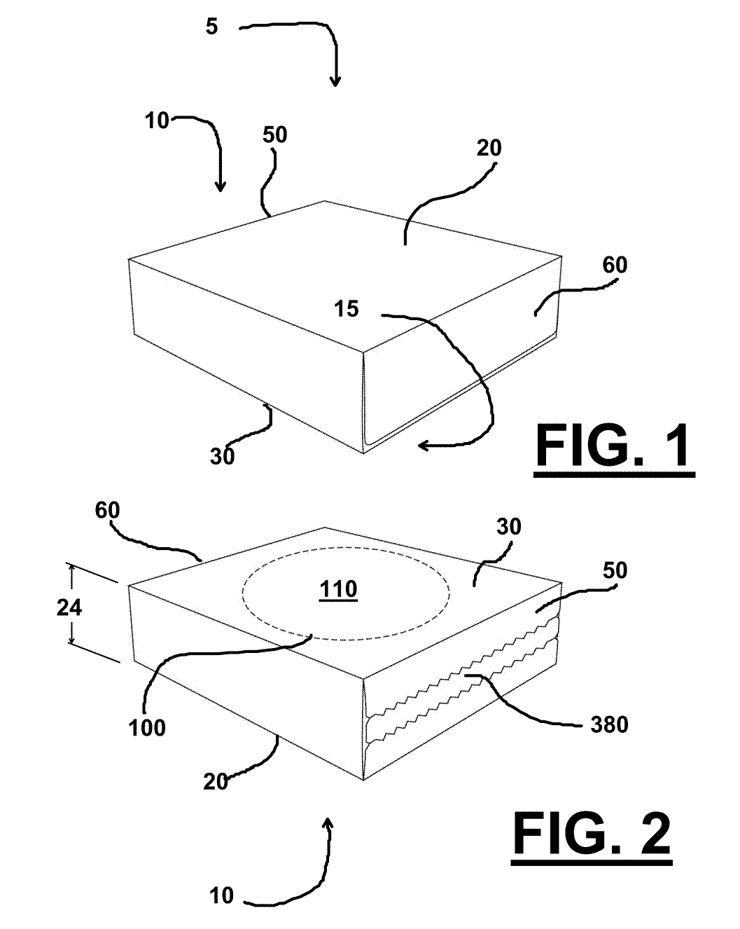

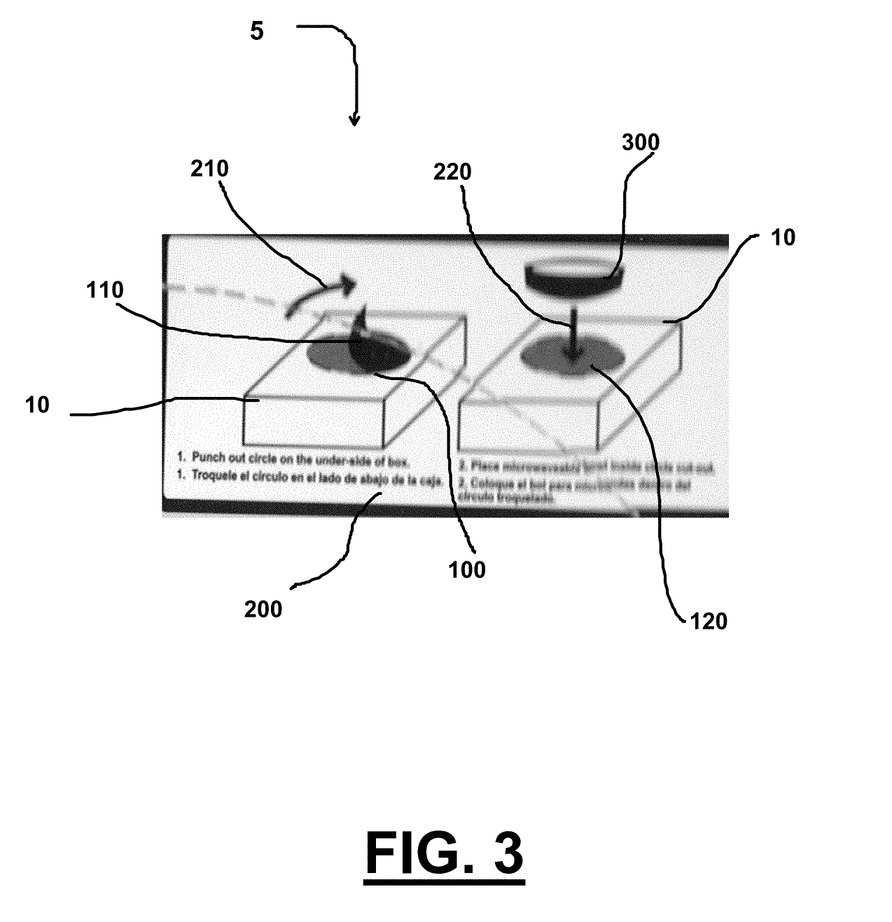

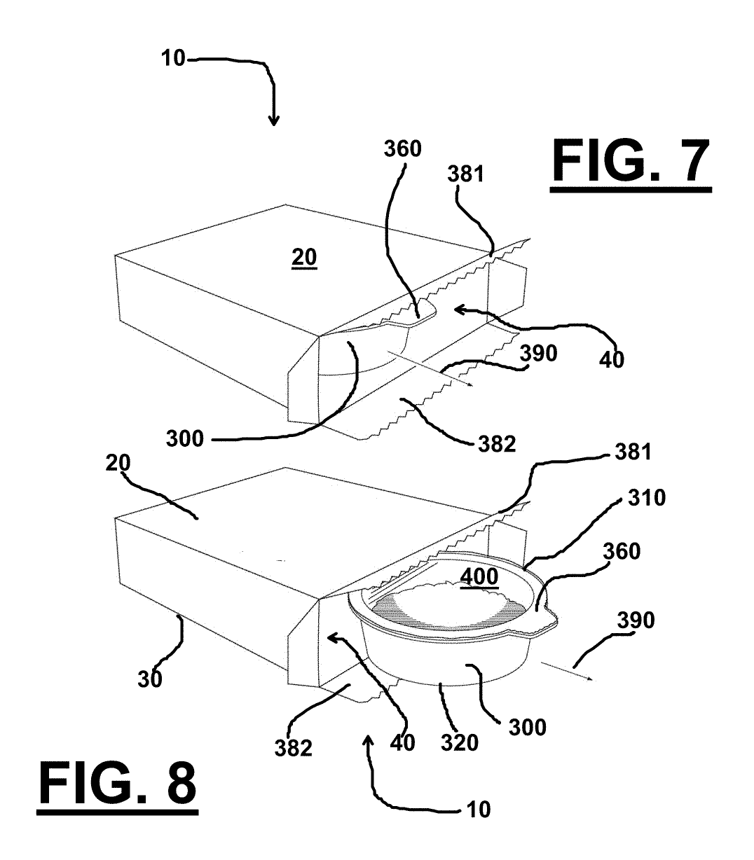

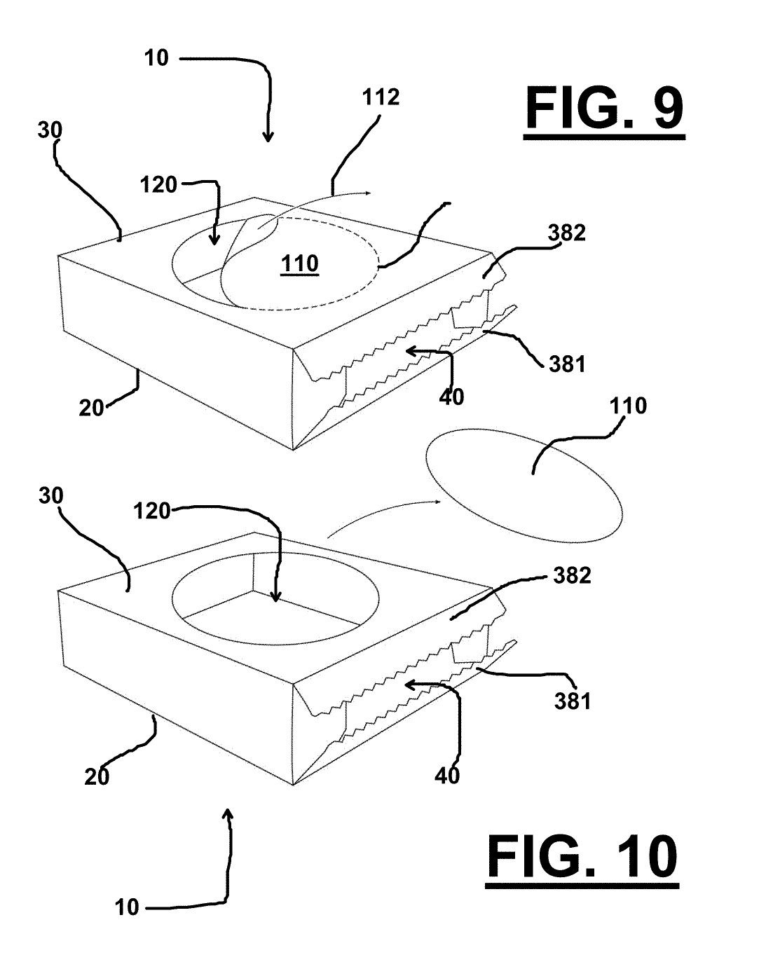

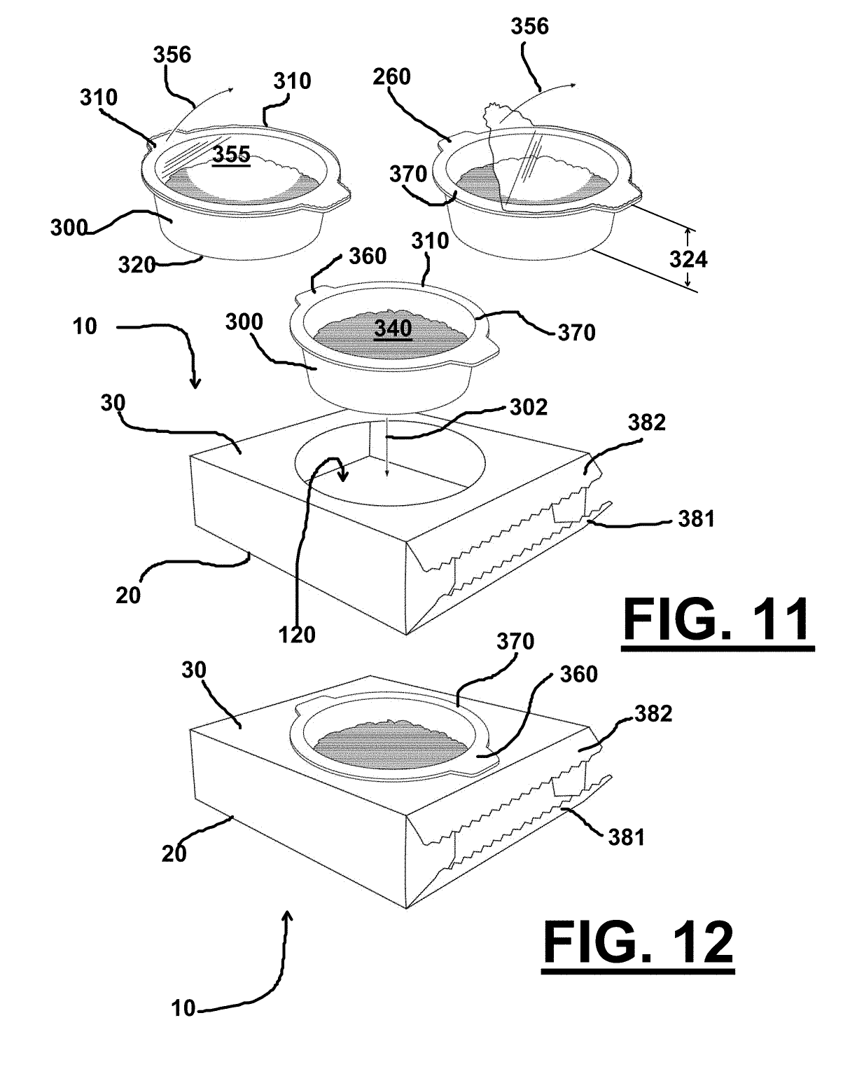

FIGS. 1-12 show the preferred embodiment of the apparatus of the present invention designated generally by the numeral 5. The apparatus 5 of the present invention provides a microwavable carton 10 having a top panel 20 and a bottom panel 30. The carton 10 has a height 24. The microwavable carton 10 provides an interior 40 that is sized and shaped to hold a microwavable food container or bowl 300. The bowl has an interior for holding food to be consumed.

The microwavable carton 10 has a first side 50 and a second side 60. In the drawings, there are a plurality of perforations or a serrated portion 100 that can be cut or severed. By cutting the perforations or serrated portion 100, a removable section 110 can be removed by a user. Once the removable section 110 is removed, an access opening 120 is formed. This access opening 120 is sized and shaped to hold container or bowl 300 and a food item that is contained in the container or bowl 300.

Notice that the microwavable carton 10 can have instructions 200. These instructions will explain to a user that the carton 10 is opened and the microwavable food container 300 is removed. The microwavable food container 300 is then placed in the opening 120 that is formed by removing the removable section 110. A film layer or cover 400 can be placed over the food contained in bowl or container 300.

The food container or bowl 300 has a top 310, bottom 320, and a height 324 of the bottom section. The bowl or microwavable food container 300 has an interior 340 containing a food product (such as frozen jambalaya). There is also provided a lower perimeter 350 and a pair of spaced apart handles 360. The container 300 also has an overlapping rim 370. Rim 370 has a diameter greater than the diameter of opening 120.

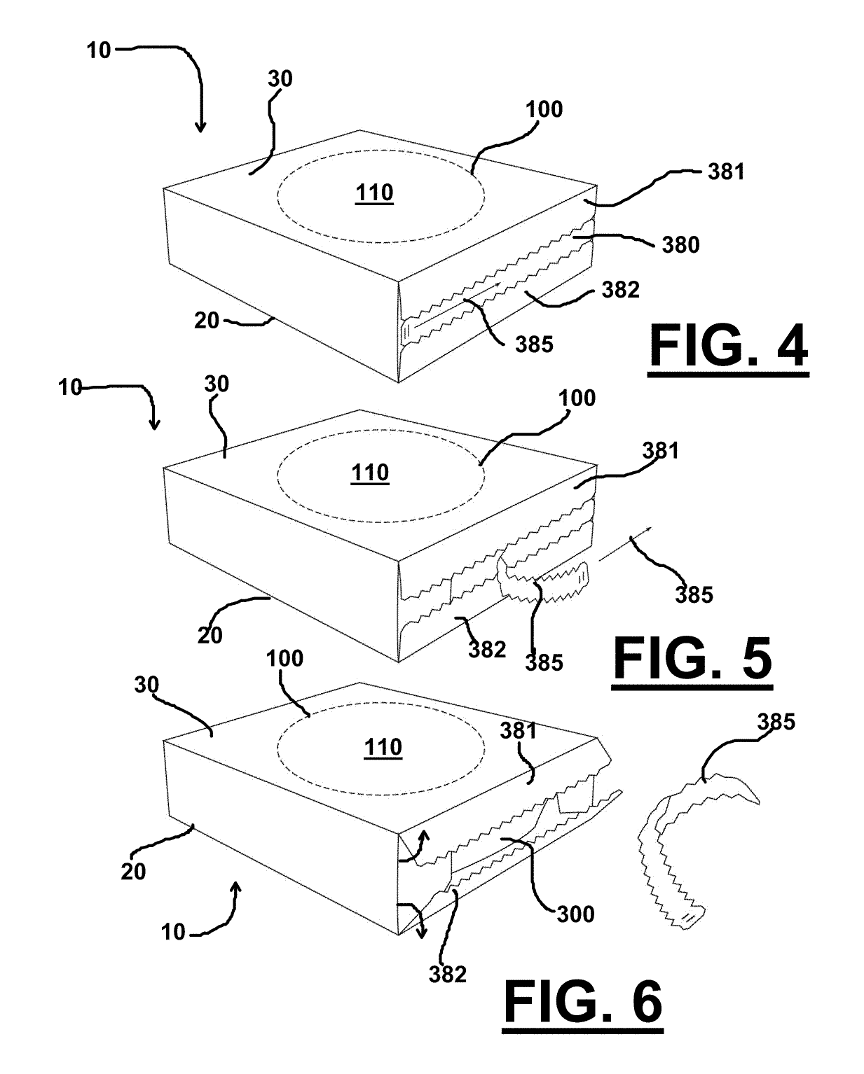

In order to use the apparatus 5, the user opens carton 10 by removing panel 380 (see FIGS. 4-6). Bowl or container 300 containing a food item is removed by grasping handle 360 and pulling in the direction of arrow 390. Container or bowl 300 can have a cover or layer of film 400. The user removes the section 110 by severing the serrated portion 100. The bowl or microwavable food container 300 is then placed in the opening 120. A user then microwaves the combination of the carton 10 and the removable food container 300 which was placed in the opening 120. Once the combination of food container 300 and carton 10 have been subjected to heat in a microwave oven, a user can safely remove the combination of carton 10 and container 300. This can be done without the danger of burns to the user's hands because the carton 10 is of a low heat transfer material such as a paper or cardboard 10. The carton 10 thus acts as a trivet when a user removes the carton 10 and food container 300 from the microwave oven. Heat is retained by the food in the bowl 300, but little or no heat is retained by the carton 10.

The following is a list of parts and materials suitable for use in the present invention:

### PARTS LIST

| PART NUMBER | DESCRIPTION |
|---|---|
| 5 | microwavable food apparatus |
| 10 | microwavable carton/box |
| 15 | arrow |
| 20 | top |
| 24 | height |
| 30 | bottom |
| 40 | interior |
| 50 | first side |
| 60 | second side |
| 100 | perforations |
| 110 | removable section |
| 112 | arrow |
| 120 | access opening |
| 200 | instructions |
| 210 | arrow |
| 215 | arrow |
| 220 | arrow |
| 300 | microwavable food container/bowl |
| 302 | arrow |
| 310 | top |
| 320 | bottom |
| 324 | height of bottom section |
| 340 | interior |
| 350 | lower perimeter |
| 355 | removable cover |
| 356 | arrow |
| 360 | handle |
| 370 | overlapping rim/annular rim |
| 380 | flap/removable panel |
| 381 | upper panel |
| 382 | lower panel |
| 390 | arrow |
| 400 | layer of film/cover |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A microwavable food and package apparatus, comprising:
a) an outer container having an upper panel providing an upper surface, a lower panel providing a lower surface, a plurality of side walls that each extend from the upper panel to the lower panel, and an interior;
b) one of the side walls having a removable portion that enables access to said interior;
c) an inner container with a bottom and a cavity that holds a food item in a pre-cooking, packaged position;
d) one of the container panels having a removable section that can be removed to provide an opening;
e) an annular wall on the inner container that is sized and shaped to fit the opening in a nested cooking position that places the inner container bottom below said opening;
f) wherein the outer container is a trivet when the inner container is fitted to the outer container in the nested position.

2-4. (canceled)

5. The microwavable food and package apparatus of claim 1 wherein the upper and lower panels are each rectangular.

6. (canceled)

7. The microwavable food and package apparatus of claim 1 wherein the inner container is a bowl.

8. The microwavable food and package apparatus of claim 1 wherein the inner container has a circular bottom.

9-10. (canceled)

11. The microwavable food and package apparatus of claim 1 wherein the inner container has one or more handles.

12. The microwavable food and package apparatus of claim 1 wherein the removable portion of the upper panel is surrounded by a serrated portion.

13. The microwavable food and package apparatus of claim 1 wherein the removable portion of the upper panel is surrounded by perforations.

14. The microwavable food and package apparatus of claim 1 wherein the removable portion of the upper panel is surrounded one or more scores.

15. A microwavable, packaged food apparatus, comprising:
a) box having an upper panel providing an upper surface, a lower panel providing a lower surface, a plurality of side walls that each extend from the upper panel to the lower panel, a plurality of box corners and an interior;
b) one of the side walls having an access portion that enables access to said interior;
c) a bowl having a bottom, a top rim, and a cavity that holds a food item to be consumed, the bowl being sized and shaped to the box interior, the bowl being sized and shaped to exit the box via the access portion;
d) one of the box panels having a having a removable section that can be removed to provide an box opening;
f) wherein the box has a poor heat transfer index as compared to the bowl.

16-23. (canceled)

24. The microwavable, packaged food apparatus of claim 15 wherein the bowl has one or more handles.

25. The microwavable, packaged food apparatus of claim 15 wherein the removable portion of the upper panel is surrounded by a serrated portion.

26. The microwavable, packaged food apparatus of claim 15 wherein the removable portion of the upper panel is surrounded by perforations.

27. (canceled)

28. The microwavable, packaged food apparatus of claim 15 wherein the bowl has an annular rim that is in between the bowl bottom and top rim, wherein said annular rim rests upon the top panel when the bowl occupies the box opening.

29. A method of cooking a food item with a microwave oven comprising the steps of:
a) providing an outer container having an upper panel with an upper surface, a lower panel with a lower surface, a plurality of side walls that each extend from the upper panel to the lower panel, a container periphery, and an interior, one of the side walls having a removable portion that enables access to said interior;
c) wherein in step “a”, an inner container with a cavity that holds a food item is contained within the outer container interior, the inner container having a bottom, an upper rim and an open top;
d) removing a section of one of the container panels to form an opening that is spaced inwardly of said periphery;
e) removing the inner container from the outer container;
f) fitting the inner container to the opening wherein the bottom is below the opening and the upper rim is above the opening;
g) heating the inner and outer containers and the food item with a microwave oven; and
h) removing the outer container from the microwave oven by a user grabbing the outer container;
i) wherein in step “h”, a portion of the outer container extends away from the inner container after the inner and outer containers have been subjected to microwave cooking so that said portion of said outer container provides a cooled surface for gripping by a user.

30. The method of claim 29 wherein the inner container has an annular surface that rests upon the outer container at the opening wherein the inner container bottom is below the opening.

31. The method of claim 29 wherein the open top of the inner container is covered with a sheet of plastic film.

32. The method of claim 29 wherein in step “d” the removable section is surrounded by perforations and further comprising removing the section by tearing the panel at the perforations.

33. The method of claim 29 wherein in step “f” the inner container bottom is spaced in between the outer container panels.

34. The method of claim 29 wherein the inner container has a height that is about equal to the distance between the upper and lower panels.

35. The method of claim 29 wherein in step “e” one of the side walls is at least partially separated from the outer container.
